(19) United States
(12) Patent Application Publication
(10) Pub. No.: US 2015/0314551 A1
(43) Pub. Date: Nov. 5, 2015

(54) MICRO-PERFORATED REFLECTIVE TEXTILE SLEEVE AND METHOD OF CONSTRUCTION THEREOF

(71) Applicant: Federal-Mogul Powertrain, Inc., Southfield, MI (US)

(72) Inventors: Ming-Ming Chen, West Chester, PA (US); Wai Kit Ho, Exton, PA (US)

(21) Appl. No.: 14/701,875

(22) Filed: May 1, 2015

Related U.S. Application Data
(60) Provisional application No. 61/987,299, filed on May 1, 2014.

(51) Int. Cl. B32B 1/08; B32B 37/18; F16L 59/08; B32B 37/14; B32B 3/26; F16L 57/04

(52) U.S. Cl. CPC B32B 1/08; B32B 3/266; F16L 57/04; F16L 59/08; B32B 37/142; B32B 37/18; B32B 2571/00

(57) ABSTRACT

A tubular sleeve for providing protection to elongate members contained within the sleeve against external radiant heat and method of construction thereof is provided. The sleeve includes an inner tubular textile wall forming a cavity sized for receipt of the elongate members and an outer foil layer bonded to an outer surface of the textile wall. The outer foil layer has micro-sized perforated holes that enhance the ability of the sleeve to be flexed and routed over meandering paths without causing the outer foil layer to tear or crack.

### CROSS-REFERENCE TO RELATED APPLICATION

This application claims the benefit of U.S. Provisional Application Ser. No. 61/987,299, filed May 1, 2014, which is incorporated herein by reference in its entirety.

### BACKGROUND OF THE INVENTION

1. Technical Field

This invention relates generally to textile sleeves for protecting elongate members, and more particularly to textile sleeves having a reflective outer surface.

2. Related Art

Tubular textile sleeves are known for use to provide protection to internally contained elongate members, such as a wire harness, cable, or hoses, for example. It is further known to apply various types of coatings, such as sprayed, plated or dipped, on textile sleeves to form a heat reflective surface on the sleeves. It is also known to apply a layer of imperforate foil on an outer surface of a sleeve, wherein the outer layer of foil provides a reflective barrier to radiant heat, thereby offering protection against the transfer of heat to the underlying sleeve material and to the elongate members contained within the sleeve. Although imperforate foil layers can be generally effective to shield the material of the sleeve and the contents therein from exposure to heat, it limits the degree to which the sleeve can be flexed without cracking and tearing.

### SUMMARY OF THE INVENTION

A tubular sleeve for providing protection to elongate members contained within the sleeve against external radiant heat is provided. The sleeve includes an inner tubular textile wall forming a cavity sized for receipt of the elongate members and an outer foil layer bonded to an outer surface of the textile wall. The outer foil layer is micro-perforated, wherein the micro-perforated holes enhance the ability of the sleeve to be flexed and routed over meandering paths without causing the outer foil layer to tear or crack. Further, the micro-size of the perforated holes does not sacrifice or otherwise impact the ability of the micro-perforated outer foil layer to perform its intended function of reflecting external radiant heat, thereby providing the same or substantially the same thermal protection to the elongate members contained within the cavity of the sleeve as compared to an imperforate foil layer. Further, by minimizing the propensity of crack or tear formation, the micro-perforated outer foil layer provides the sleeve with enhanced durability and life expectancy relative to non-perforated foil layered sleeves.

In accordance with another aspect of the invention, the micro-perforated holes can have a generally uniform density over the substantial entirety of the foil layer.

In accordance with another aspect of the invention, the micro-perforated holes can range between about 50-300 μm in diameter.

In accordance with another aspect of the invention, the micro-perforated holes can range between about 50-100 μm in diameter.

In accordance with another aspect of the invention, the micro-perforated holes have a density between about 300-340 holes per square inch.

In accordance with another aspect of the invention, the inner textile wall can be formed from interlaced yarn filaments.

In accordance with another aspect of the invention, the inner textile wall can be formed from a nonwoven material.

In accordance with another aspect of the invention, the micro-perforated outer foil layer can be spiral wrapped about the inner textile wall.

In accordance with another aspect of the invention, the micro-perforated outer foil layer can have opposite edges overlapped in bonded relation with one another.

In accordance with another aspect of the invention, the inner textile wall can be a closed, seamless circumferentially continuous wall.

In accordance with another aspect of the invention, the inner textile wall can be an open wall having lengthwise extending opposite edges biased into overlapping relation with one another.

In accordance with another aspect of the invention, a foil tape having micro-perforated holes can be applied over at least a portion of a seam formed between the overlapped edges.

In accordance with another aspect of the invention, a method of constructing a tubular sleeve for providing protection to elongate members contained within the sleeve against external radiant heat is provided. The method includes forming an inner textile wall of the sleeve having opposite inner and outer surfaces. The method further includes bonding an outer foil layer to the outer surface, with the inner surface remaining configured to bound a cavity sized for receipt of the elongate members therein. Further yet, the method includes providing the outer foil layer with micro-perforated holes, wherein the micro-perforated holes provide the sleeve with an ability to be flexed and routed over meandering paths without tearing or cracking the outer foil layer.

In accordance with another aspect of the invention, the method can include forming the micro-perforated holes having a generally uniform density over the entirety of the outer foil layer.

In accordance with another aspect of the invention, the method includes forming the micro-perforated holes ranging between about 50-300 μm in diameter, and more preferably between about 50-100 μm in diameter.

In accordance with another aspect of the invention, the method includes perforating the micro-sized holes having a density between about 300-340 holes per square inch.

In accordance with another aspect of the invention, the method can include forming the inner textile wall from interlaced yarn filaments.

In accordance with another aspect of the invention, the method can include forming the inner textile wall from a nonwoven material.

In accordance with another aspect of the invention, the method can include spiral wrapping the outer foil layer about the inner textile wall.

In accordance with another aspect of the invention, the method can include forming the inner textile wall as a closed, seamless circumferentially continuous wall.

In accordance with another aspect of the invention, the method can include forming the inner textile wall as an open wall having opposite edges extending along a length of the sleeve, with the opposite edges being biased into overlapping relation with one another.

### BRIEF DESCRIPTION OF THE DRAWINGS

These and other aspects, features and advantages of the invention will become readily apparent to those skilled in the art in view of the following detailed description of the presently preferred embodiments and best mode, appended claims, and accompanying drawings, in which:

FIG. 1 is a schematic perspective view of a protective textile sleeve constructed in accordance with one aspect of the invention shown disposed about an elongate member to be protected from external radiant heat;

FIG. 1A is a partial schematic view of an inner wall constructed in accordance with one aspect of the invention of the sleeve of FIG. 1;

FIG. 1B is a partial schematic view of an inner wall constructed in accordance with one aspect of the invention of the sleeve of FIG. 1;

FIG. 2 is a cross-sectional view taken generally along the line 2-2 of FIG. 1;

FIG. 3 is a schematic perspective view of a protective textile sleeve constructed in accordance with another aspect of the invention shown disposed about an elongate member to be protected from external radiant heat;

FIG. 4 is a schematic perspective view of a protective textile sleeve constructed in accordance with another aspect of the invention shown disposed about an elongate member to be protected from external radiant heat;

FIG. 5 is a schematic perspective view of a protective textile sleeve constructed in accordance with another aspect of the invention shown disposed about an elongate member to be protected from external radiant heat; and

FIG. 6 is a schematic perspective view of a protective textile sleeve constructed in accordance with another aspect of the invention shown disposed about an elongate member to be protected from external radiant heat.

### DETAILED DESCRIPTION OF PREFERRED EMBODIMENTS

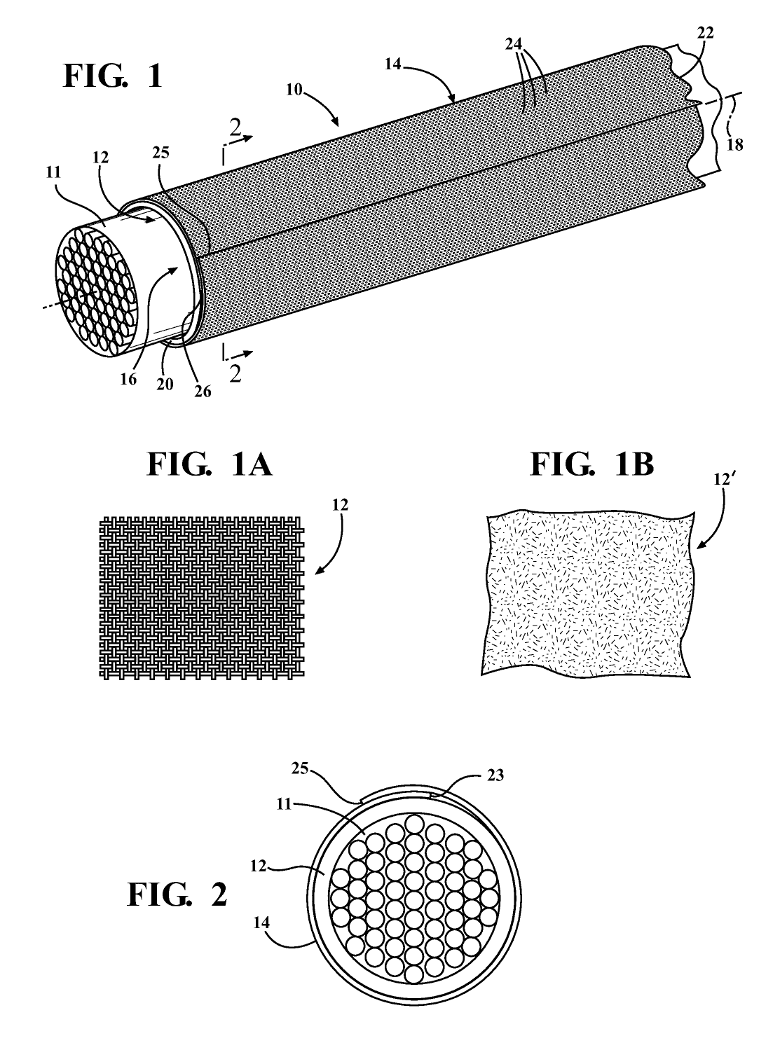

Referring in more detail to the drawings, FIG. 1 shows a tubular textile sleeve, referred to hereafter as sleeve 10, constructed according to one embodiment of the invention for providing protection against external radiant heat to elongate members, such as a hose, wires, or a wire harness 11, by way of example and without limitation, contained within the sleeve 10. The sleeve 10 has an inner wall 12, illustrated in FIG. 1 as a seamless and circumferentially continuous wall, with a reflective outer layer 14 bonded to an outer surface of the inner wall 12. The inner wall 12 has an inner surface that defines a central cavity 16 sized for receipt of the elongate members 11 therein, wherein the cavity 16 extends axially along a central longitudinal axis 18 between opposite ends 20, 22 of the sleeve 10. The reflective outer layer 14 provides a thermal barrier to the inner wall 12 and the elongate members 11 against external radiant heat, thereby protecting the elongate members 11 against unwanted exposed to external radiant heat. The reflective outer layer 14 is provided as an outermost layer, preferably as a layer of foil, such as aluminum, by way of example and without limitation, having micro-perforated holes 24. The micro-perforated holes 24 enhance the ability of the sleeve 10 to be flexed and routed over meandering paths without tearing or cracking the foil outer layer 14. Further, with the micro-perforated holes 24 being micro-sized, it has been found via experimentation that the holes 24, as formed in accordance with the invention, do not sacrifice or otherwise lessen the ability of the outer foil layer 14 to perform its intended function of reflecting external radiant heat, thereby providing insulative protection to the elongate members 11 contained within the cavity 16 of the sleeve 10. Further, by minimizing the propensity of crack or tear formation in the thin foil outer layer 14, the foil outer layer 14 provides the sleeve 10 with enhanced durability and life expectancy relative to imperforate foil layered sleeves.

The inner wall 12 can be constructed having any suitable length and diameter, depending on the application and size of the elongate member 11 to be protected. The inner wall 12 can be constructed from any suitable interlaced yarn filaments (FIG. 1A), including monofilaments and/or multifilaments, via weaving, knitting, braiding, having a desired interlace pattern for the intended application, or from a layer of nonwoven material 12′ (FIG. 1B). Accordingly, the inner wall 12 can be constructed having various structural properties and configurations.

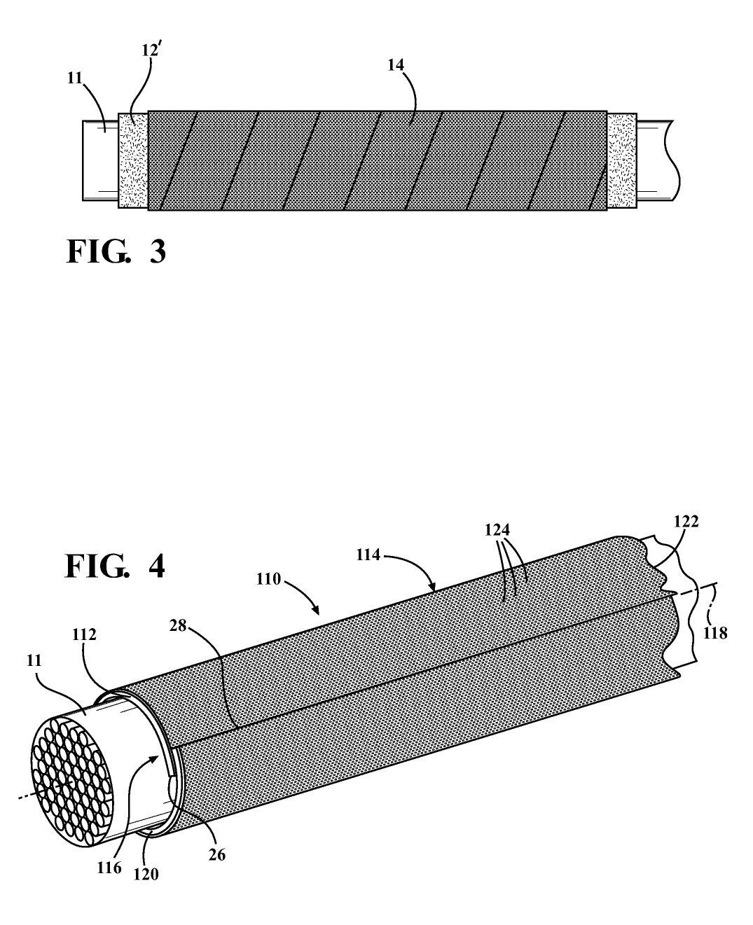

The foil outer layer 14 is provided as a standard thickness wrappable foil, and has micro-sized perforate holes 24 ranging between about 50-300 μm in diameter, and more preferably ranging between about 50-100 μm in diameter, and in one example, were formed being 50 μm in diameter. The holes 24 are formed over the entirety or substantial entirely of the foil outer layer 14 having a generally uniform density between about 300-340 holes per square inch, and in one example, were formed having a generally uniform density of about 320 holes per square inch. The size and density of the holes 24 have been found to provide the sleeve 10 with enhance flexibility without causing the foil outer layer 14 to tear or crack in use, such as while being bent or routed over meandering paths, while also retaining the emissivity of the foil outer layer 14 as compared to an imperforate sheet of the foil, thereby being fully functional to protect inner wall 12 and the elongate members 11 within the cavity 16 of the sleeve 10 from exposure to external radiant heat. The foil outer layer 14 can be provided in rectangular sheets sized to be “cigarette” wrapped about the inner wall 12 to bring opposite edges 23, 25 of the foil outer layer 14 into overlapping, bonded relation with one another, as best shown in FIG. 2, or it can be provided in a suitable width elongate strip and then spiral wrapped about the wall 12, as desired (FIG. 3). Any suitable adhesive can be used to facilitate bonding the foil outer layer 14 to an outer surface of the inner wall 12.

In FIG. 4, a sleeve 110 constructed in accordance with another aspect of the invention is shown, wherein the same reference numerals, offset by a factor of 100, are used to identify like features.

The sleeve 110 has an inner wall 112 constructed as a wrappable wall, and can be formed as a self-wrapping, “cigarette” type wall, if desired. As such, the inner wall 112 has opposite edges 26, 28 extending generally parallel to a central longitudinal axis 118 between opposite ends 120, 122 of the sleeve 110, wherein the opposite edges 26, 28 are brought into overlapping relation with one another to circumferentially bound a central cavity 116. Upon forming the inner wall 112, such as from interlaced yarn filaments (FIG. 1A) or a nonwoven material (FIG. 1B), as discussed above, the wall 112 can be laminated with a foil outer layer 114, wherein the foil outer layer 114 is formed from the same metal foil materials and with the same size and density of micro-sized holes 124 as discussed above, preferably over the entirety of the foil outer layer 114. Upon laminating the foil outer layer 114 to an outer surface of the inner wall 112, the laminated wall can be wrapped into its tubular form to bring the opposite edges 26, 28 into overlapping relation with one another. If the inner wall 124 is formed at least in part from heat-settable material, whether from a nonwoven material or interlaced yarn filaments, the inner wall 112 can be heat-set to take on a self-wrapping configuration, such that the opposite edges 26, 28 are automatically biased into overlapping relation with one another in the absence of an externally applied force. If the inner wall 114 is formed from interlaced yarn, at least some of the circumferentially extending yarn filaments can be provided as heat-settable yarn filaments to facilitate heat-setting the inner wall 114 into a tubular configuration. With the foil outer layer 114 fully covering an outer surface of the inner wall 112, the entire circumference of the sleeve 110 is assured of being covered by the foil outer layer 114. This said, it is to be understood that the opposite edges 26, 28 can remain free to be biased by an externally applied force to open the sleeve 110 along its length to facilitate placing the sleeve about the elongate member 111 or to remove the sleeve 110 from the elongate member 111, such as during service.

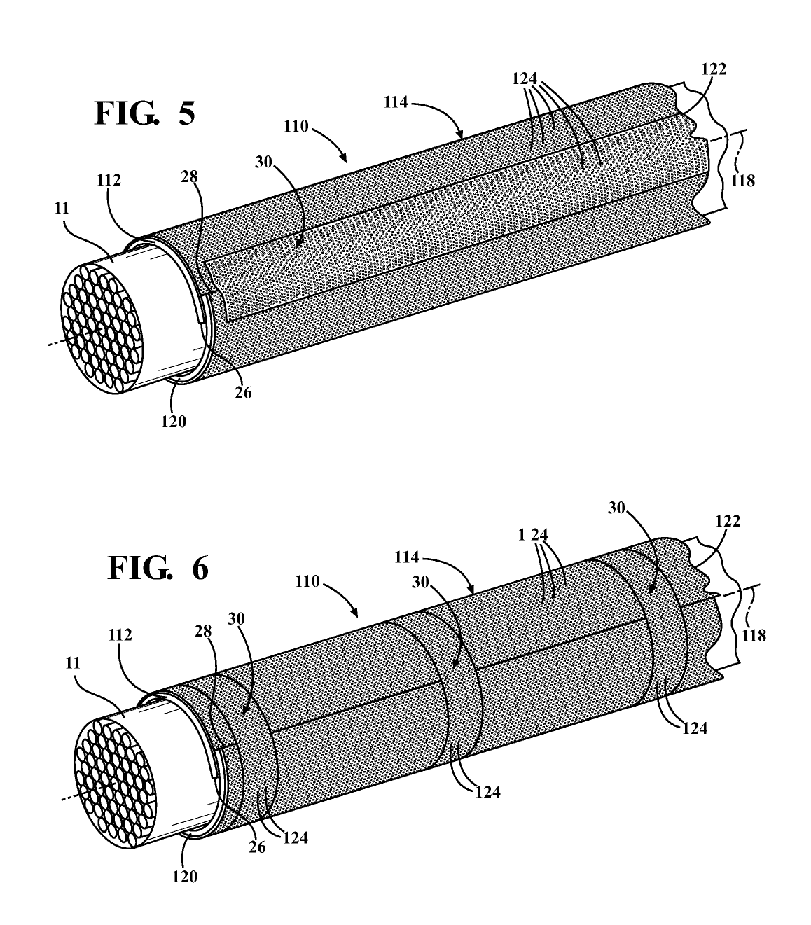

In accordance with another aspect of the invention, as shown in FIG. 5, if desired, a perforated strip of foil tape 30, having the same size, pattern and density of holes 124, as discussed above, can be applied along at least a portion of, or along the entirety of the seam formed by the overlapping edges 26, 28 to completely seal the seam between the overlapping edges 26, 28. As such, the perforated foil tape 30 can be applied as a single strip over the entirety overlapping edges 26, 28 in generally parallel relation to the axis 118 to prevent the opposite edges 26, 28 from being inadvertently opened and to prevent the ingress of contamination. Otherwise, as shown in FIG. 6, it should be recognized that individual strips of the perforated foil tape 30 could be wrapped circumferentially about the sleeve 110, if desired, thereby preventing the opposite edges 26, 28 from being inadvertently opened.

It should be recognized that sleeves 10, 110 constructed in accordance with the invention are suitable for use in a variety of applications, regardless of the sizes and lengths required. For example, they could be used in automotive, marine, industrial, aeronautical or aerospace applications, or any other application wherein protective sleeves are desired to protect nearby components against heat radiation.

It is to be understood that the above detailed description is with regard to some presently preferred embodiments, and that other embodiments readily discernible from the disclosure herein by those having ordinary skill in the art are incorporated herein and considered to be within the scope of any ultimately allowed claims.

What is claimed is:

1. A protective sleeve for providing protection to elongate members contained within the sleeve against external radiant heat, comprising:
an inner textile wall having an outer surface and an inner surface, said inner surface being configured to bound a cavity for receipt of the elongate members; and
an outer foil layer bonded to said outer surface of said textile wall, said outer foil layer having micro-perforated holes.

2. The protective sleeve of claim 1 wherein said micro-perforated holes have a generally uniform density over the substantial entirety of said foil layer.

3. The protective sleeve of claim 2 wherein said micro-perforated holes have a diameter between about 50-300 μm.

4. The protective sleeve of claim 3 wherein said micro-perforated holes have a diameter between about 50-100 μm.

5. The protective sleeve of claim 1 wherein said micro-perforated holes have a diameter between about 50-300 μm.

6. The protective sleeve of claim 1 wherein said inner textile wall has opposite edges extending along a longitudinal axis of said sleeve between opposite ends, said opposite edges be wrapped about said longitudinal axis in overlapping relation with one another.

7. The protective sleeve of claim 6 wherein said inner textile wall is heat-set to bias said opposite edges in overlapping relation with one another.

8. The protective sleeve of claim 6 wherein said inner textile wall is formed of interlaced yarn filaments.

9. The protective sleeve of claim 6 wherein said inner textile wall is formed of a nonwoven material.

10. The protective sleeve of claim 6 wherein said overlapped opposite edges form a seam along the length of said inner textile wall, and further including a foil tape bonded over at least a portion of said seam, said foil tape having micro-perforated holes.

11. The protective sleeve of claim 10 wherein said foil tape extends over the substantial entirety of said seam.

12. The protective sleeve of claim 1 wherein said inner textile wall is circumferentially continuous.

13. The protective sleeve of claim 12 wherein said outer foil layer has opposite edges overlapping one another.

14. The protective sleeve of claim 12 wherein said outer foil layer is spiral wrapped about said inner textile wall.

15. A method of constructing a tubular sleeve for providing protection to elongate members contained within the sleeve against external radiant heat, comprising:
forming an inner textile wall having an outer surface and an inner surface configured to bound a cavity for receipt of the elongate members; and
bonding an outer foil layer to said outer surface of said textile wall, said outer foil layer having micro-perforated holes.

16. The method of claim 15 further including forming said micro-perforated holes having a generally uniform density over the substantial entirety of said foil layer.

17. The method of claim 16 further including forming said micro-perforated holes having a diameter between about 50-300 μm.

18. The method of claim 17 further including forming said micro-perforated holes having a diameter between about 50-100 μm.

19. The method of claim 15 further including forming said micro-perforated holes having a diameter between about 50-300 μm.

20. The method of claim 15 further including forming said inner textile wall having opposite edges extending along a longitudinal axis of said sleeve between opposite ends and wrapping said opposite edges about said longitudinal axis in overlapping relation with one another.

21. The method of claim 20 further including heat-setting said inner textile wall to bias said opposite edges in overlapping relation with one another.

22. The method of claim 20 further including forming said inner textile with interlaced yarn filaments.

23. The method of claim 20 further including forming said inner textile wall with nonwoven material.

24. The method of claim 20 further including bonding a foil tape having micro-perforated holes over at least a portion of a seam formed between said opposite edges.

25. The method of claim 24 further including bonding said foil tape over the substantial entirety of said seam.

26. The method of claim 15 further including forming said inner textile wall being circumferentially continuous.

27. The method of claim 26 further including bonding opposite edges of said outer foil layer in overlapping relation one another.

28. The method of claim 26 further including spiral wrapping said outer foil layer about said inner textile wall.
